(19) United States
(12) Patent Application Publication
(10) Pub. No.: US 2018/0297226 A1
(43) Pub. Date: Oct. 18, 2018

(54) RAZOR BLADE HAVING WAVY CUTTING EDGE

(71) Applicant: Byung Jin KIM, Seoul (KR)

(72) Inventor: Byung Jin KIM, Seoul (KR)

(21) Appl. No.: 15/489,137

(22) Filed: Apr. 17, 2017

(51) Int. Cl. B26B 21/56; B26B 21/40

(52) U.S. Cl. CPC B26B 21/56; B26B 21/4031

(57) ABSTRACT

Disclosures relate to a razor blade includes a bottom cutting edge. The bottom cutting edge has a wavy shape including convex portions and concave portions.

### TECHNICAL FIELD

The disclosure generally relates to a razor blade configured for use in a shaver or razor, and more particularly, to a razor blade having a wavy cutting edge.

### BACKGROUND

Three types of razor blades are commonly used. The most common type is the straight blade which is shown in FIG. 1A. The other types are the convexly curved blade (or the “smiley” blade) which is shown in FIG. 1B, and the concavely curved blade (or the “frowning” blade) which is shown in FIG. 1C. The reasons people use different types of blades are that different contours of faces require different pressures of shaving, and that different angles or directions of hair require different angles or directions of blades. That is, in order to perform close shaving, different types of razor blades are needed for different people.

Meanwhile, while some people generally perform a satisfactory shave in about 30 sweeps of the razor, some others take more than 1,200 sweeps of the razor. Although the greater number of sweeps can be caused by personal habit, this is also possible that different people need different optimal positioning of the blade in order to perform close and clean shave by themselves.

Additionally, it is not always the case the shaver makes a sweep by positioning the blade perpendicular to the direction the shaver is sweeping. In other words, in some cases, slanted shaving (like a guillotine with a slanted blade falling vertically to the ground) can be more efficient. That is, some people perform shaving in different ways.

Thus, some embodiments in this disclosure propose razor blades which can provide shaving with different angles when contacting a skin so that a user can shave his or her skin with less sweeps and closer shave.

### SUMMARY

In some embodiments, a razor blade includes a bottom cutting edge, wherein the bottom cutting edge has a wavy shape including convex portions and concave portions.

In some embodiments, a razor head includes a plurality of razor blades each of which includes a bottom cutting edge having a wavy shape.

### DESCRIPTION OF DRAWINGS

Details of one or more implementations are set forth in the accompanying drawings and the description below, by way of example, and not by limitation. Other features, aspects, and potential advantages will be apparent from the description and drawings.

FIGS. 1A-1C are schematic views of conventional razor blades.

FIGS. 2A-2B are schematic views of a razor blade having a sinusoidal wavy cutting edge in accordance with one or more embodiments.

FIGS. 3A-3D are schematic views of razor blades having sinusoidal wavy cutting edges with particularly honed surfaces in accordance with one or more embodiments.

FIGS. 4A-4C are schematic views of a razor head including a plurality of razor blades having sinusoidal wavy cutting edges in accordance with one or more embodiments.

FIGS. 5A-5F are schematic views of cutting hair by razor blades having sinusoidal wavy cutting edges in accordance with one or more embodiments.

FIG. 6 is a schematic view of a razor head including a plurality of razor blades having sinusoidal wavy cutting edges in accordance with one or more embodiments.

FIGS. 7A-7B are schematic views of a razor blade having a square wavy cutting edge in accordance with one or more embodiments.

FIGS. 8A-8C are schematic views of razor blades having square wavy cutting edges with particularly honed surfaces in accordance with one or more embodiments.

FIGS. 9A-9C are schematic views of a razor head including a plurality of razor blades having square wavy cutting edges in accordance with one or more embodiments.

FIGS. 10A-10C are schematic views of cutting hair by razor blades having square wavy cutting edges in accordance with one or more embodiments.

FIG. 11 is a schematic view of a razor head including a plurality of razor blades having square wavy cutting edges in accordance with one or more embodiments.

FIG. 12 is a schematic side view of a way to pressure a skin by a razor head including a plurality of razor blades in accordance with one or more embodiments.

### DETAILED DESCRIPTION

The following disclosure provides many different embodiments, or examples, for implementing different features of the disclosed subject matter. Specific examples of components and arrangements are described below to simplify the present disclosure. These are examples and are not intended to be limiting.

In the following detailed description, reference is made to the accompanying figures, which form a part hereof. In the figures, similar symbols typically identify similar components, unless the context dictates otherwise. The illustrative embodiments described in the detailed description, figures, and claims are not meant to be limiting. Other embodiments are also utilized, and other changes are also made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

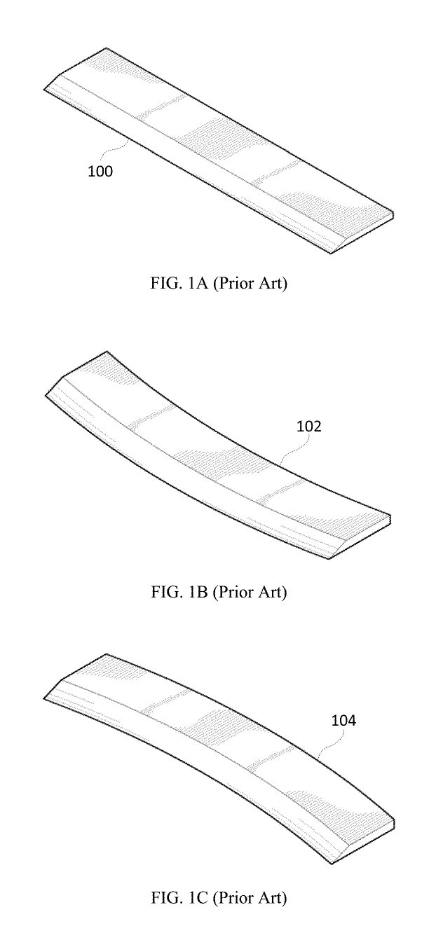

FIGS. 1A-1C are schematic views of conventional razor blades.

FIG. 1A shows a straight blade having side 100 to be touched the skin, FIG. 1B shows smiley blade 102, and FIG. 1C shows frown blade 104.

As aforementioned, hair is grown at a variety of angles, e.g., 31 degree to 59 degree. Each hair forms a different angle between the skin (or surface) and the hair. If it is assumed that each razor is perpendicular to the direction of the blade moving then as pointed, a razor blade cutting these hairs from different direction leaves different shape of the cut hair. This is the reason why people make more than one sweeps in different directions in the same area of the skin to accomplish close shave. Additionally, slanting the razor and making a sweep can result in different shape of cut hair, since the hair grows in different directions and the fact that the surrounding (skin) of the hair are irregular in shape.

Since hair can grow in any direction and the shape of the skin around the hair is different, shavers tend to shave the hair on the same spot several times from different angles (making several sweeps) or using different shaped razors while applying different pressures in order to achieve close shave.

In present disclosure, wavy blades that provide different cutting angles and apply different pressures on the skin, implying minimal number of sweeps, are introduced.

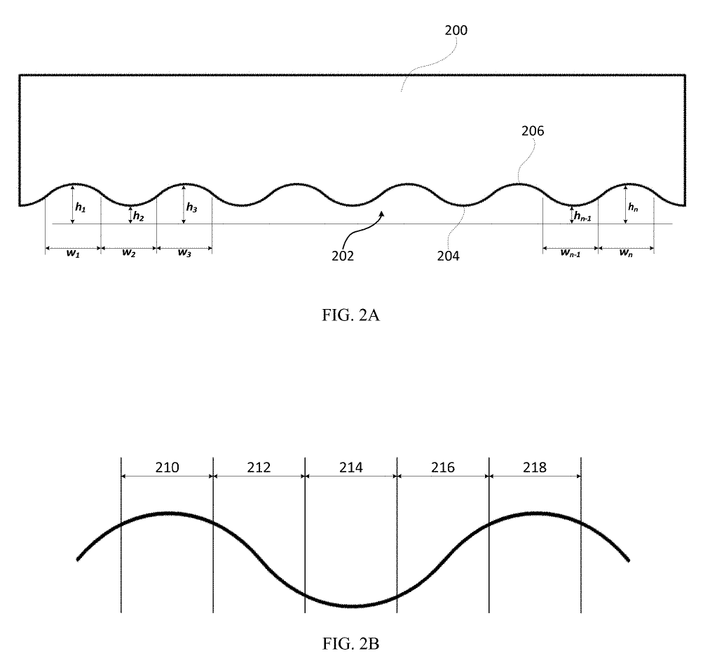

FIGS. 2A-2B are schematic views of razor blade 200 having a sinusoidal wavy cutting edge 202 in accordance with one or more embodiments.

FIG. 2A shows the razor blade 200 having the bottom cutting edge which has a wavy shape that is a sinusoidal wave shape. The sinusoidal wave shape includes convex portions 204 and concave portions 206. The blade can be distinguished by height and width of each wave. As shown in FIG. 2A, the first (or the left most) “wave” (concave wave; peak) is defined by height h₁, and its width w₁, the second “wave” (convex wave; valley) is defined by height h₂, and its width w₂, and the last “wave” (concave wave) is defined by height hₙ, and its width wₙ. Each wavy shaped blade includes n number of these “waves”. In some embodiments, all the heights and widths are the same. In other embodiments, all the heights and widths are not necessarily the same. Also, in some embodiments, height hₖ (k=1, 2 . . . n) is measured from the absolute position to the peak (mathematically, the point where the slope is 0) of each wave. In this setting hₖ where k is odd indicates concave waves whereas hₖ where k is even indicates convex waves.

FIG. 2B shows “zones” of the sinusoidal wave shape. When hairs are cut in the areas indicated in 210 then the concave cut is applied. This is the same for the areas indicated in 218. When hairs are cut in the areas indicated in 212 then the left-right slanted cut is applied. When hairs are cut in the areas indicated in 214 then the convex cut is applied. Finally, when hairs are cut in the areas indicated in 216 then the right-left slanted cut is applied.

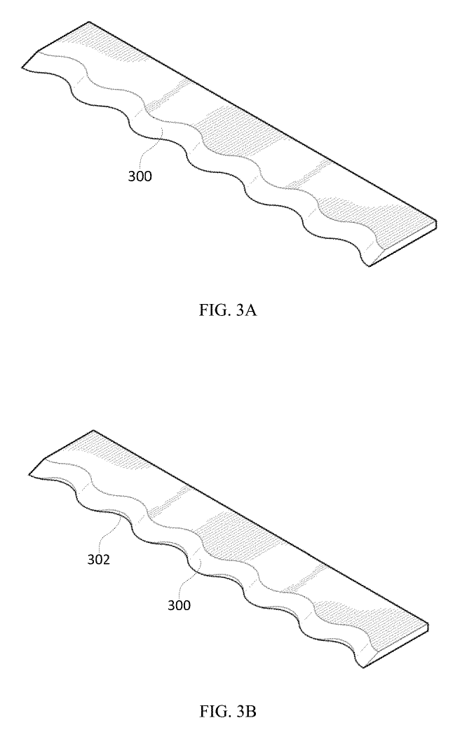

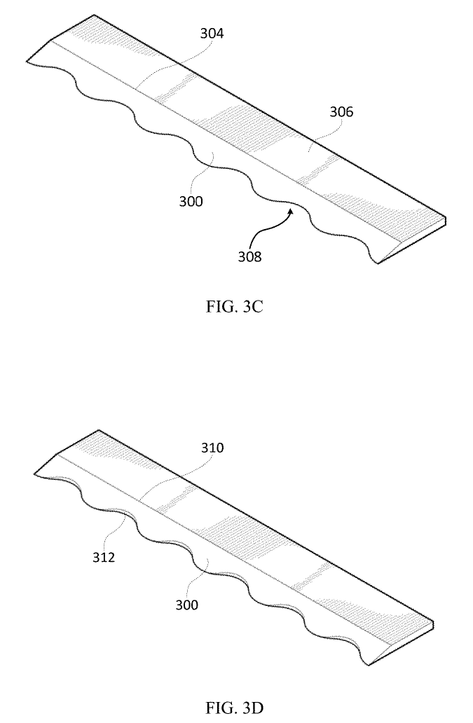

FIGS. 3A-3D are schematic views of razor blades having sinusoidal wavy cutting edges with particularly honed surfaces 300 in accordance with one or more embodiments.

In some embodiments, the razor blade is a flat blade having even front and back surfaces.

FIG. 3A shows the razor blade having the honed surface 300 having the wavy shape corresponding to the sinusoidal wave shape of the bottom cutting edge. FIG. 3B shows the razor blade including the honed surface 300 having the wavy shape corresponding to the sinusoidal wave shape of the bottom cutting edge, and the concave portions having curved bottom portions 302. Curved bottom portions 302 are not sharp edges, but curved surfaces. FIG. 3C shows the razor blade including the honed surface 300 having straight end line 304. Straight edge 304 is disposed between body 306 of the razor blade and sinusoidal wavy cutting edge 308 of the razor blade. FIG. 3D shows the razor blade including the honed surface 300 having straight end line 310, and the concave portions having curved bottom portions 312. Curved bottom portions 312 are not sharp edges, but curved surfaces.

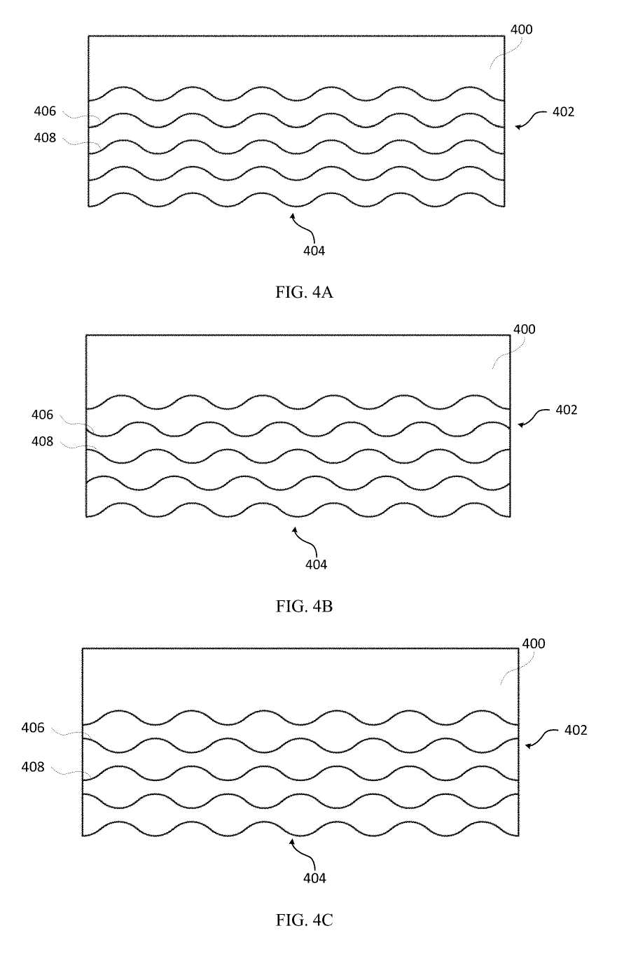

FIGS. 4A-4C are schematic views of razor head 400 including a plurality of razor blades 402 having sinusoidal wavy cutting edges 404 in accordance with one or more embodiments.

FIG. 4A shows the razor head including a plurality of razor blades each of which includes a bottom cutting edge having a sinusoidal wave shape and is arranged so that one sinusoidal wave shape 406 is aligned with directly adjacent sinusoidal wave shapes 408. FIG. 4B shows the razor head including a plurality of razor blades each of which includes a bottom cutting edge having a sinusoidal wave shape and is arranged so that one sinusoidal wave shape 406 is not aligned with directly adjacent sinusoidal wave shapes 408. FIG. 4C shows the razor head including a plurality of razor blades each of which includes a bottom cutting edge having a sinusoidal wave shape and is arranged so that one sinusoidal wave shape 406 is symmetrical with directly adjacent sinusoidal wave shapes 408.

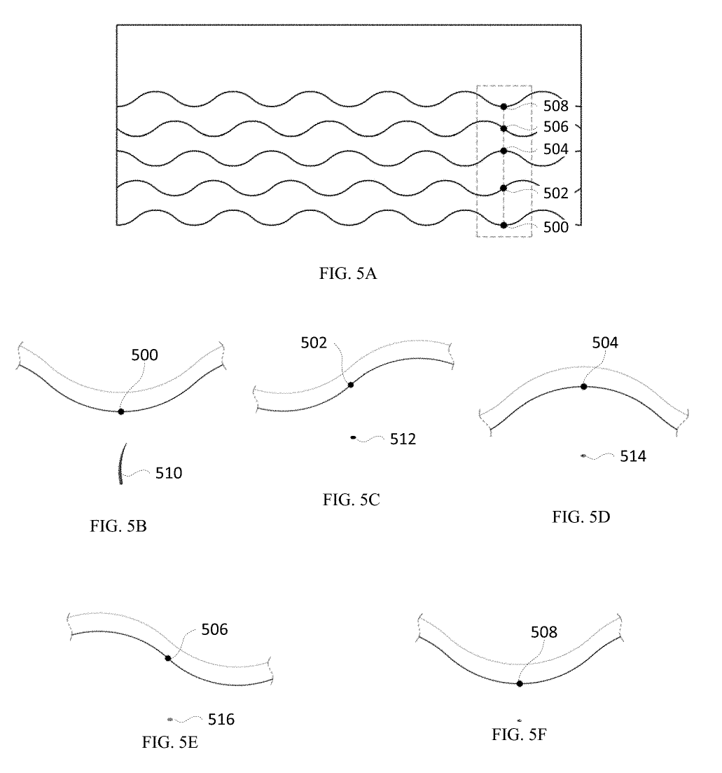

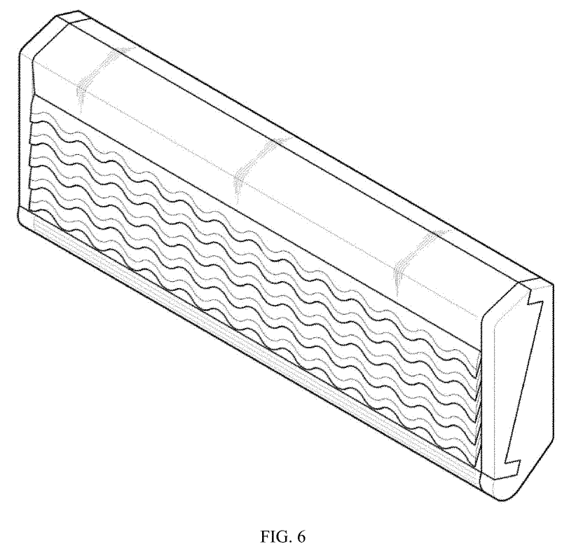

FIGS. 5A-5F are schematic views of cutting hair by razor blades having sinusoidal wavy cutting edges in accordance with one or more embodiments.

FIG. 5A shows the wavy razor blades grouped together as FIG. 4B. The advantage of the shaver per some embodiments is described in a case where a hair is right below point 500. When the shaver (a user) performs a sweep, the hair is firstly cut by the blade at point 500 and the spot where the hair is cut is cut again by the blade at point 502 and so on. Therefore, points 500, 502, 504, 506, and 508 pass the same spot. Note that point 500 lies on the first blade, point 502 lies on the second blade, and so on.

FIG. 5B illustrates the blade around point 500 and hair 510. Once the shaver performs a sweep, hair 510 is cut at point 500. In this case, the convex cut is applied on the hair. Once the hair is cut, the first blade passes the cut hair and, as illustrated in FIG. 5C, point 502 of the second blade cuts the already cut hair at spot 512. In this case, the right-left slanted cut is applied on spot 512. After the second blade passes spot 512, as illustrated in FIG. 5D, point 504 of the third blade cuts the hair left from spot 512. In this case, the concave cut is applied on spot 514. After the third blade passes spot 514, as illustrated in FIG. 5E, point 506 of the fourth blade cuts the hair left from spot 514. In this case, the left-right slanted cut is applied on spot 516. Finally, after the fourth blade passes 516, as illustrated in FIG. 5F, point 508 of the fifth blade cuts the hair left from spot 516. In this case, the convex cut is applied again and cuts what is left from the passing of the fourth blade.

As illustrated in FIGS. 5B-5F, grouping the wavy blade together in a different alignment, with one single sweep of the shaver can apply four different cuts at the same spot. Since different pressures and shaving angles are applied, on the same spot several times, this provides a close and clean shave.

FIG. 6 is a schematic view of a razor head including a plurality of razor blades having sinusoidal wavy cutting edges in accordance with one or more embodiments. In some embodiments, the razor head including a plurality of razor blades each of which includes a bottom cutting edge having a wavy shape and is arranged so that one wavy shape is aligned with directly adjacent wavy shapes.

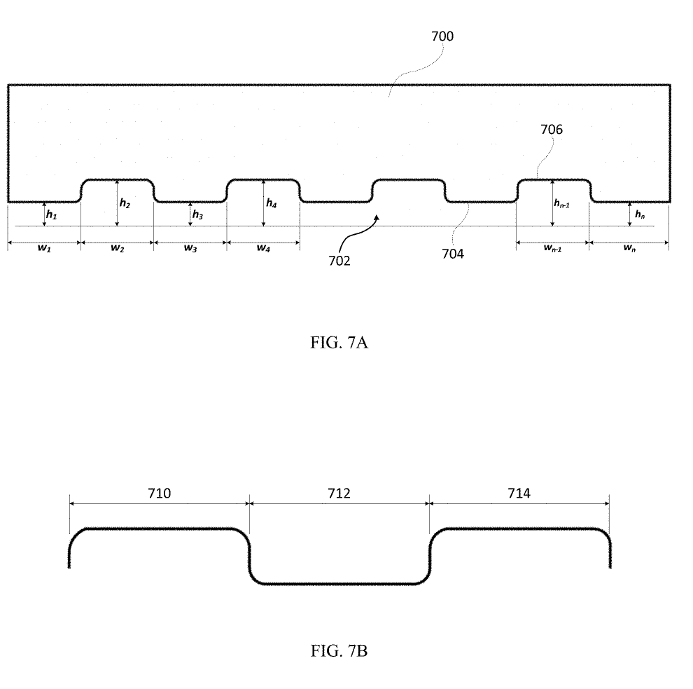

FIGS. 7A-7B are schematic views of razor blade 700 having square wavy cutting edge 702 in accordance with one or more embodiments.

FIG. 7A shows the razor blade 700 having the bottom cutting edge which has a wavy shape that is a square wave shape. The square wave shape includes convex portions 704 and concave portions 706. The blade can be distinguished by height and width of each wave. As shown in FIG. 7A, the first (or the left most) “wave” (convex wave) is defined by height h₁, and its width w₁, the second “wave” (concave wave) is defined by height h₂, and its width w₂, and the last “wave” (convex wave) is defined by height hₙ, and its width wₙ. Each wavy shaped blade includes n number of these “waves”. In some embodiments, all the heights and widths are the same. In other embodiments, all the heights and widths are not necessarily the same. Also, note that height hₖ (k=1, 2, . . . n) is measured from the absolute position to the flat area of each wave. In this setting hₖ where k is odd indicates convex waves whereas hₖ where k is even indicating concave waves. Each of the convex portions and the concave portions has rectangular shapes with rounded corners.

FIG. 7B shows “zones” of the square wave shape. When hairs are cut in the areas indicated in 710 then the concave cut is applied. This is the same for the areas indicated in 714. When hairs are cut in the areas indicated in 712 then the convex cut is applied.

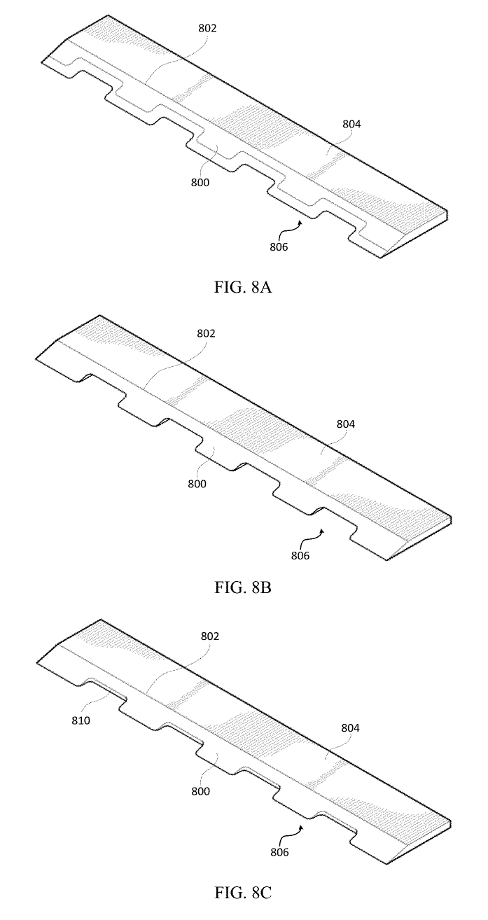

FIGS. 8A-8C are schematic views of razor blades having square wavy cutting edges with particularly honed surfaces 800 and straight end line 802 that is disposed between the body 804 of the razor blade and square wavy cutting edge 806 in accordance with one or more embodiments.

FIG. 8A shows the razor blade including a honed surface 800 having a wavy shape corresponding to the square wave shape of the bottom cutting edge 806. Straight end line 802 is disposed between body 804 of the razor blade and square wavy cutting edge 806. In this particular blade, all parts of the square wavy edges are honed. FIG. 8B shows the razor blade including a honed surface 800 having straight end line 802. In this particular blade, the convex and concave parts of the square wavy edges are honed (the side between the convex and concave parts are not honed). FIG. 8C shows the razor blade including a honed surface 800 having the straight end line 802. In this particular blade, only the convex parts of the square wavy edges are honed. The bottom portions 810 are not sharp edges.

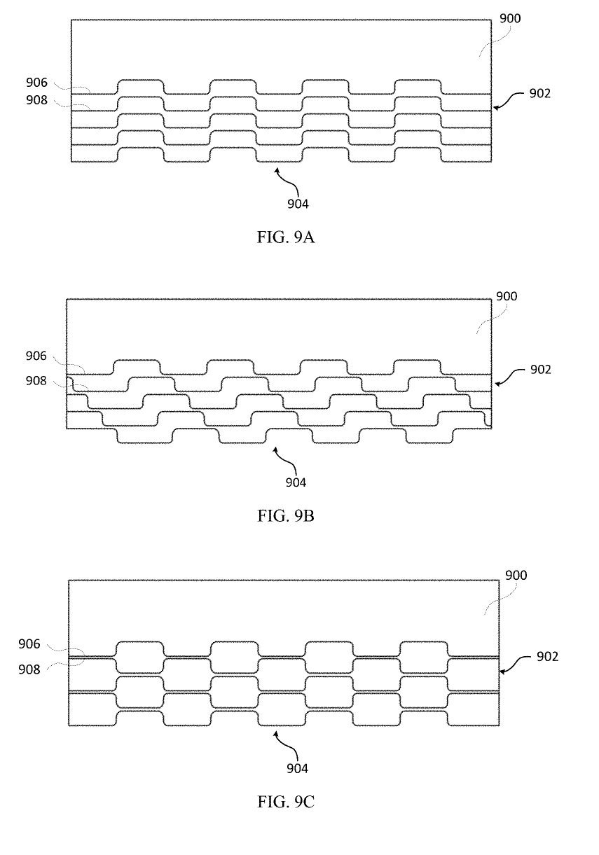

FIGS. 9A-9C are schematic views of razor head 900 including a plurality of razor blades 902 having square wavy cutting edges 904 in accordance with one or more embodiments.

FIG. 9A shows the razor head including a plurality of razor blades each of which includes a bottom cutting edge having a square wave shape and is arranged so that one square wave shape 906 is aligned with directly adjacent square wave shapes 908. FIG. 9B shows the razor head including a plurality of razor blades each of which includes a bottom cutting edge having a square wave shape and is arranged so that one square wave shape 906 is not aligned with directly adjacent square wave shapes 908. FIG. 9C shows the razor head including a plurality of razor blades each of which includes a bottom cutting edge having a square wave shape and is arranged so that one square wave shape 906 is symmetrical with directly adjacent square wave shapes 908.

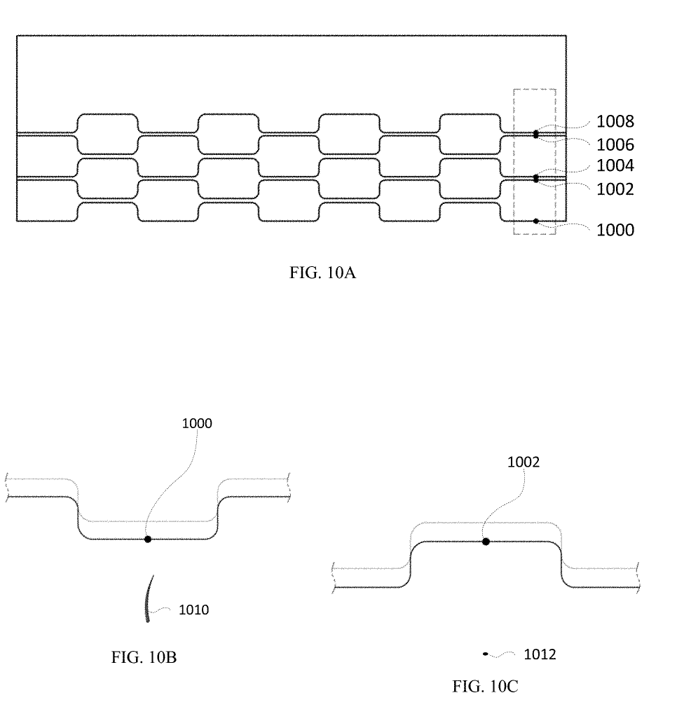

FIGS. 10A-10C are schematic views of cutting hair by razor blades having square wavy cutting edges in accordance with one or more embodiments.

FIG. 10A shows the wavy razor blades grouped together as FIG. 9C. The advantage of the shaver per some embodiments is described in a case where a hair is right below point 1000. When the shaver (a user) performs a sweep, the hair is firstly cut by the blade at point 1000 and the spot where the hair is cut is cut again by the blade at point 1002 and so on. Therefore, points 1000, 1002, 1004, 1006, and 1008 pass the same spot. Note that point 1000 lies on the first blade, point 1002 lies on the second blade, and so on.

FIG. 10B illustrates the blade around point 1000 and hair 1010. Once the shaver performs a sweep, hair 1010 is cut at point 1000. In this case, the straight convex cut is applied on the hair. Once the hair is cut, the first blade passes the cut hair and, as illustrated in FIG. 10C, point 1002 of the second blade cuts the already cut hair 1012. In this case, the straight concave cut is applied on spot 1012. When the second blade passes spot 1012, point 1004 of the third blade, point 1006 of the fourth blade, and point 1008 of the last blade passes spot 1012, applying straight convex cut, straight concave cut, and straight convex cut, respectively.

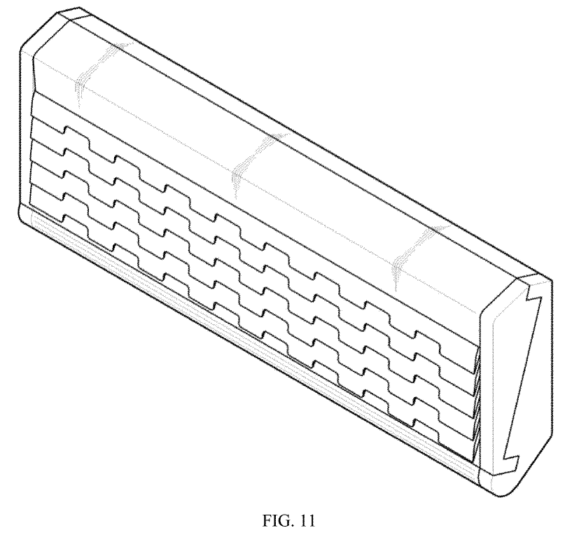

FIG. 11 is a schematic view of a razor head including a plurality of razor blades having square wavy cutting edges in accordance with one or more embodiments. In some embodiments, the razor head including a plurality of razor blades each of which includes a bottom cutting edge having a square wave shape and is arranged so that one square wave shape is aligned with directly adjacent square wave shapes.

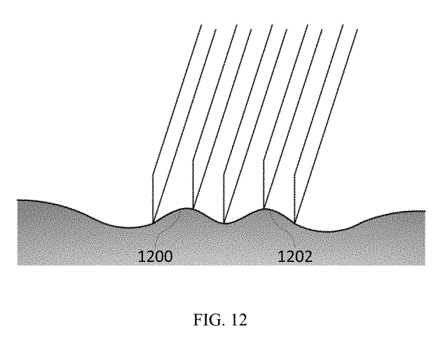

FIG. 12 is a schematic side view of a way to pressure a skin by a razor head including a plurality of razor blades in accordance with one or more embodiments.

In accordance with the conventional shaver, multiple straight razors are aligned perfectly, and therefore, the pressure is uniformly applied on the skin where the blades touch the skin. This cause the skin that touches the blades to be flat. This in turn applies the same type of cut (straight cut in this case) on the cut hairs repeatedly. On the contrary, in some embodiments of the present disclosure, as shown in FIG. 12, by multiple razor blades not aligned, the convex zone of the first blade is followed by a slanted zone or a concave zone so that the shaver makes humps as illustrated in 1200 and 1202 with the right pressure. This provides the effect of squeezing and pressing the area the blade is touching and therefore, gives a various type of cuts when the blade cuts the hairs. Even though the razors are aligned, the alignments still make humps (from front view) and thus provides the effect of squeezing and pressing the area the blade is touching.

It will be readily seen by one of ordinary skill in the art that the disclosed embodiments fulfill one or more of the advantages set forth above. The configuration and the method of the embodiments per the present disclosure, described above, are not applied in a limiting manner, but all or some of the embodiments may be selectively combined with each other to create various modifications to the embodiments.

It will also be apparent to those skilled in the art that various modifications and variations can be made in the present disclosure without departing from the spirit or scope of the disclosure. Thus, it is intended that the present disclosure cover modifications and variations of this disclosure provided they come within the scope of the appended claims and their equivalents.

What is claimed is:

1. A razor blade, comprising:
a bottom cutting edge,
wherein the bottom cutting edge has a wavy shape including convex portions and concave portions.

2. The razor blade of claim 1, wherein the razor blade is a flat blade that has even front and back surfaces.

3. The razor blade of claim 1, wherein the wavy shape has a sinusoidal wave shape.

4. The razor blade of claim 3, wherein each of the convex portions and the concave portions has the same height and the same width.

5. The razor blade of claim 1, wherein the convex portions and the concave portions include peaks and valleys.

6. The razor blade of claim 3, wherein the razor blade comprises a honed surface having a wavy shape corresponding to the sinusoidal wave shape of the bottom cutting edge.

7. The razor blade of claim 6, wherein the concave portions have curved bottom portions.

8. The razor blade of claim 3, wherein the razor blade comprises a honed surface having a straight end line.

9. The razor blade of claim 8, wherein the concave portions have curved bottom portions.

10. The razor blade of claim 1, wherein the wavy shape is a square wave shape.

11. The razor blade of claim 10, wherein each of the convex portions and the concave portions has the same height and the same width.

12. The razor blade of claim 10, wherein each of the convex portions and the concave portions has a rectangular shape with rounded corners.

13. The razor blade of claim 10, wherein the razor blade comprises a honed surface having a wavy shape corresponding to the square wave shape of the bottom cutting edge.

14. The razor blade of claim 13, wherein the concave portions have curved bottom portions.

15. The razor blade of claim 10, wherein the razor blade comprises a honed surface having a straight end line.

16. The razor blade of claim 15, wherein the concave portions have curved bottom portions.

17. A razor head, comprising a plurality of razor blades each of which includes a bottom cutting edge having a wavy shape.

18. The razor head of claim 1, wherein each razor blade is arranged so that one wavy shape is aligned with directly adjacent wavy shapes.

19. The razor head of claim 1, wherein each razor blade is arranged so that one wavy shape is not aligned with directly adjacent wavy shapes.

20. The razor head of claim 1, wherein each razor blade is arranged so that one wavy shape is symmetrized with directly adjacent wavy shapes.
